(19) United States
(12) Patent Application Publication
(10) Pub. No.: US 2026/0121212 A1
(43) Pub. Date: Apr. 30, 2026

(54) TRACTION BATTERY FOR A MOTOR VEHICLE

(71) Applicant: Dr. Ing. h.c. F. Porsche Aktiengesellschaft, Stuttgart (DE)

(72) Inventors: Alexander Eichinger, Westheim (DE); Fadi Renz, Remseck am Neckar (DE)

(73) Assignee: Dr. Ing. h.c. F. Porsche Aktiengesellschaft, Stuttgart (DE)

(21) Appl. No.: 19/365,324

(22) Filed: Oct. 22, 2025

(30) Foreign Application Priority Data
Oct. 24, 2024 (DE) 102024130952.0

(51) Int. Cl. H01M 50/342; B60L 50/64; H01M 50/249; H01M 50/262; H01M 50/276; H01M 50/278

(52) U.S. Cl. CPC H01M 50/3425; B60L 50/64; H01M 50/249; H01M 50/262; H01M 50/276; H01M 50/278; H01M 2220/20

(57) ABSTRACT

A traction battery for a motor vehicle includes a battery housing. The battery housing includes a top plate having a weakened point. A method for manufacturing such a traction battery and a motor vehicle including such a battery are described herein.

### CROSS-REFERENCE TO RELATED APPLICATION

This application claims priority to German Patent Application No. 10 2024 130 952.0, filed Oct. 24, 2025, the content of such application being incorporated by reference herein in its entirety.

### FIELD OF THE INVENTION

The present invention relates to a traction battery for a motor vehicle with a battery housing. Furthermore, the present invention relates to a method for manufacturing a traction battery and a motor vehicle.

### BACKGROUND OF THE INVENTION

Motor vehicles with an electrified powertrain feature an electric motor, power electronics for supplying the electric motor, and a traction battery for providing electrical energy.

The traction battery is an element of the drive train that receives special attention in safety considerations. If a local short circuit occurs in the traction battery, for example due to mechanical damage in an accident or contamination of the separator, the short-circuit current heats up the immediate vicinity of the damaged area due to the internal resistance of the traction battery, which expels flammable gases and leads to a self-reinforcing, heat-producing process known as thermal runaway. If thermal runaway reaches neighboring cells and spreads to them, it can cause a kind of chain reaction. This is referred to as thermal propagation.

To minimize damage caused by the expelled hot gases, degassing channels are typically provided on the outside or inside of the traction battery housing. The degassing channels allow the hot gases to be discharged from the battery in a controlled manner and cooled and filtered during discharge. To prevent an opening between the interior of the battery housing and the exterior of the battery housing from being created by the degassing channels, the battery housing is typically sealed with a bursting element at the transition to the degassing channels. Such sealing elements are mounted on openings in the battery housing and seal them. If the pressure inside the traction battery rises due to thermal runaway, the bursting elements break and open the opening.

Described herein is a traction battery, a method for manufacturing a traction battery, and a motor vehicle which makes it possible to omit additional burst elements in the traction battery and allows for simple and cost-effective manufacture of the traction battery.

### SUMMARY OF THE INVENTION

The traction battery according to aspects of the invention is a traction battery for a motor vehicle. A battery housing of the traction battery has a top plate. The top plate is a cover that closes the battery housing. According to aspects of the invention, the top plate is provided with a weakened point. The weakened point is a spot where the structure of the top plate has been deliberately weakened. As a result it is possible to define a point on the top plate at which the top plate breaks open when a certain excess pressure builds up inside the traction battery, thus providing an opening for the targeted discharge of gases from the battery housing. Additional burst elements and associated interventions in the structure of the battery housing are therefore not necessary apart from the top plate. As a result, installation space is saved and the weakened point of the battery housing can be taken into account directly during the manufacture of the top plate, making the manufacture of the traction battery easier and more cost-effective.

The weakened point is preferably designed in the form of a closed curve. As a result a defined opening can be created in a beneficial manner when tearing open the top plate at the weakened point, which corresponds to the inside of the closed curve.

According to a preferred embodiment of the present invention, the top plate has a smaller wall thickness at the weakened point than away from the weakened point, wherein the weakened point preferably comprises a V-shaped or U-shaped recess in the top plate. As a result a beneficial structural weakening is achieved, which enables the top plate to be torn open in a targeted manner. It is conceivable that the V- or U-shaped recess is located on the inside of the top plate. However, it is also conceivable that the V- or U-shaped recess is located on both the inside and outside of the top plate.

It is particularly preferred that the weakened point is produced by material removal, preferably by laser and/or engraving. As a result the top plate can be manufactured very cost-effectively with the weakened point. Furthermore, laser cutting and engraving are very precise, whereby the tear resistance of the weakened point can be adjusted correctly.

Alternatively, it is particularly preferred that the weakened point is produced by non-material-removing forming, wherein the weakened point is preferably produced by punching and/or cup drawing and/or stretch deep drawing and/or thermoforming. This makes it possible to conveniently provide for the introduction of the weakened point directly during the manufacture of a three-dimensional structure of the top plate. For example, it is conceivable that a region of the top plate could be raised or lowered by cup drawing or deep drawing. This reduces the material thickness in the raised or recessed region or at the edges of the raised or recessed region.

According to another preferred embodiment of the present invention, the top plate is provided with a first material and a second material. The first material has a higher tear resistance than the second material. The weak spot has a higher proportion of the second material than the other parts of the top plate. As a result it is possible to create the weakened point in a beneficial way while maintaining a consistent wall thickness. As a result recesses on the top plate are eliminated, resulting in a smooth surface.

A particularly preferred embodiment of the present invention provides for the top plate to have ribs and/or beads away from the weakened point to stiffen the top plate. As a result the mechanical strength of the top plate is improved away from the weakened point in a beneficial way. It is conceivable that the weakened point is caused by the absence of ribs and/or beads to stiffen the top plate.

According to a further preferred embodiment of the present invention, it is provided that the top plate comprises aluminum and/or that the top plate comprises a plastic, wherein the top plate is preferably made of aluminum or wherein the top plate is preferably made of plastic. Aluminum and plastic enable the production of very lightweight top plates, which are highly suitable for tearing open at defined weakened points.

In particular, it is intended that the top plate is screwed to the battery housing. As a result a strong connection between the top plate and the rest of the battery housing is enabled. It is conceivable that a seal is provided between the top plate and the rest of the battery housing so that hot gases from inside the battery housing can only escape through the opening created when the top plate is torn open at the weakened point.

Another subject matter of the present invention for solving the task formulated at the outset is a method for manufacturing a traction battery, wherein a battery housing with a top plate is provided and the top plate is provided with a weakened point. In particular, it is envisaged that the traction battery is a traction battery according to aspects of the invention.

All details, features, and advantages previously disclosed in connection with the traction battery according to aspects of the invention also apply to the method according to aspects of the invention and to the motor vehicle according to aspects of the invention.

### BRIEF DESCRIPTION OF THE DRAWINGS

Further details, features, and advantages of the invention can be found in the drawings as well as from the following description of preferred embodiments based on the drawings. The drawings illustrate only exemplary embodiments of the invention, which do not restrict the concept of the invention.

FIG. 1 schematically illustrates a traction battery according to an exemplary embodiment of the present invention.

FIG. 2 schematically illustrates a top plate of a traction battery according to another exemplary embodiment of the present invention.

FIG. 3 shows a schematic cross-sectional view of a top plate of a traction battery according to another exemplary embodiment of the present invention.

FIG. 4 shows a schematic cross-sectional view of a top plate of a traction battery according to another exemplary embodiment of the present invention.

FIG. 5 schematically illustrates a top plate of a traction battery according to another exemplary embodiment of the present invention.

FIG. 6 schematically illustrates a motor vehicle according to an exemplary embodiment of the present invention.

### DETAILED DESCRIPTION OF THE INVENTION

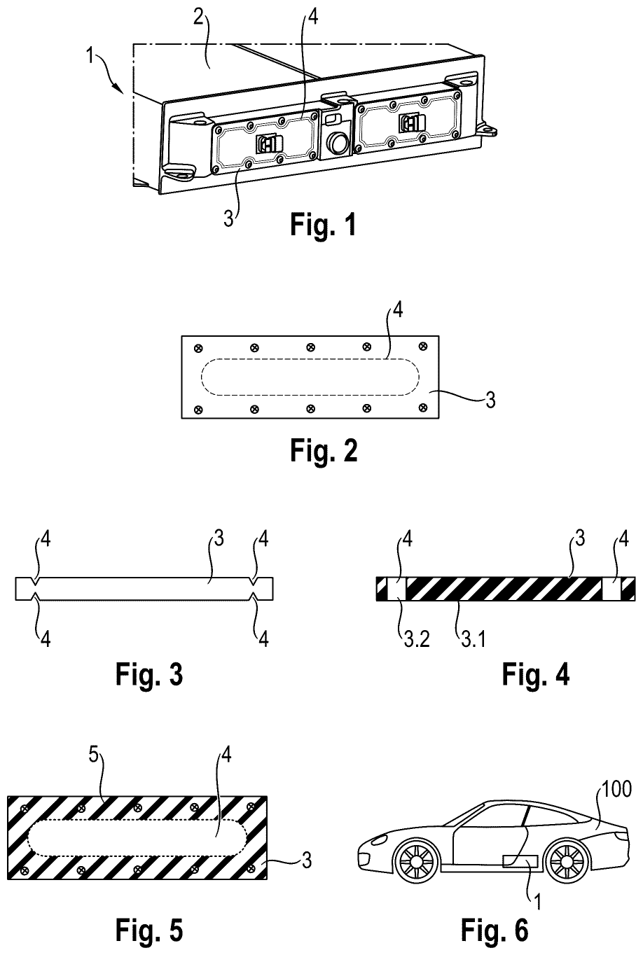

FIG. 1 schematically illustrates a traction battery 1 according to an exemplary embodiment of the present invention. The traction battery 1 is a traction battery 1 of a motor vehicle 100 (see FIG. 6).

The traction battery 1 has a battery housing 2. A top plate 3 is screwed to the battery housing 2 at the head end of the battery housing 2 and closes the battery housing 2.

To seal the interior of the battery housing 2, a gasket (not shown) is provided on the top plate 3. As a result it is ensured that no dust or water can enter the battery housing 2.

In rare cases, thermal propagation may occur in battery 1, causing hot gases to be expelled. In this context, it is extremely important to channel the hot gases out of the battery housing 2 in a controlled manner and, for example, to cool and filter them. In order to provide an opening in the battery housing 2, which releases the high-pressure gases to the outside when necessary, the top plate 3 has weakened points 4. The weakened points 4 are locations in the top plate 3 whose structural integrity fails when the maximum internal pressure of the battery housing 2 is reached and at which the top plate 3 is torn open. Tearing open the top plate 3 provides a defined path for the hot gases to escape from inside the battery housing 2.

In the embodiments shown here, the weakened points 4 are designed as closed curves so that the part enclosed by the weakened points 4 breaks away during thermal propagation.

FIG. 1 shows weakened points 4, which are produced by cup drawing or stretch drawing. Unlike deep drawing, no material flows during forming, so that the wall thickness at the weakened points 4 is reduced. The forming process has resulted in a bulge where, depending on the technique used, either the side walls of the bulge or the bottom region of the bulge are thinner than the rest of the top plate 3.

FIG. 2 shows an alternative to this. The FIG. shows the top plate 3, in which the weakened points 4 are created by punching, laser cutting, or engraving. This can also be seen in FIG. 3, which shows a sectional view of the top plate 3. The V-shaped recesses at the weakened points 4, which were created by material removal during laser cutting or engraving or by displacement during punching, are clearly visible.

Another alternative to this is shown in FIG. 4. FIG. 4 also shows a sectional view of the top plate 3, which in this case is manufactured using two different materials. A first material 3.1 of the top plate 3 has a higher tear resistance than a second material 3.2 of the top plate 3. The weakened points 4 are formed by the fact that the proportion of the second material 3.2 is significantly higher in their region than away from the weakened points 4.

FIG. 5 shows a top plate 3, which is stiffened by ribs 5 or beads. The ribs 5 or beads are arranged only away from the weakened point 4, so that the weakened point 4 is significantly less rigid and therefore more likely to tear open in the event of overpressure than the regions of the top plate 3 surrounding the weakened point 4.

### LIST OF REFERENCE NUMERALS

1 Traction battery
2 Battery housing
3 Top plate
3.1 First material
3.2 Second material
4 Weakened point
5 Rib
100 Motor vehicle

What is claimed is:

1. A traction battery of a motor vehicle comprising:
a battery housing including a top plate having a weakened point.

2. The traction battery according to claim 1, wherein the top plate has a smaller wall thickness at the weakened point than an overall wall thickness of the top plate, wherein the weakened point comprises a V-shaped or U-shaped recess in the top plate.

3. The traction battery according to claim 1, wherein the weakened point is produced by material removal, laser and/or engraving.

4. The traction battery according to claim 1, wherein the weakened point is produced by non-material-removing forming, punching, cup drawing, stretch deep drawing and/or thermoforming.

5. The traction battery according to claim 1, wherein the top plate comprises a first material and a second material, wherein the first material has a higher tear resistance than the second material, wherein the weakened point has a higher proportion of the second material as compared with other regions of the top plate.

6. The traction battery according to claim 1, wherein the top plate has ribs and/or beads that are spaced apart from the weakened point to stiffen the top plate.

7. The traction battery according to claim 1, wherein the top plate comprises aluminum and/or plastic.

8. The traction battery according to claim 1, wherein the top plate is screwed to a remainder of the battery housing.

9. A motor vehicle comprising the traction battery according to claim 1.

10. A method for manufacturing a traction battery, said method comprising:
forming a weakened point in a top plate of a battery housing.

11. The method according to claim 10, wherein the weakened point is formed by material removal, laser and/or engraving.

12. The method according to claim 10, wherein the weakened point is formed by non-material-removing forming, punching, cup drawing, stretch deep drawing and/or thermoforming.

13. The method according to claim 10, further comprising forming the top plate from a first material and a second material, wherein the first material has a higher tear resistance than the second material, wherein the weakened point has a higher proportion of the second material as compared with other regions of the top plate.

14. The method according to claim 10, further comprising forming ribs and/or beads in the top plate that are spaced apart from the weakened point.

15. The method according to claim 10, wherein the top plate comprises aluminum and/or plastic.

16. The method according to claim 10, further comprising screwing or fastening the top plate to a remainder of the battery housing.

17. The method according to claim 10, wherein the weakened point comprises a V-shaped or U-shaped recess in the top plate.
